(19) United States
(12) Patent Application Publication
(10) Pub. No.: US 2025/0360694 A1
(43) Pub. Date: Nov. 27, 2025

(54) ECO-FRIENDLY PLASTIC FLOORING FORMULA AND PRODUCT MADE THEREFROM

(71) Applicant: M.J.INTERNATIONAL FLOORING AND INTERIOR PRODUCTS INC., NEW TAIPEI CITY (TW)

(72) Inventor: BEN-YUAN CHEN, NEW TAIPEI CITY (TW)

(21) Appl. No.: 18/764,778

(22) Filed: Jul. 5, 2024

(30) Foreign Application Priority Data
May 23, 2024 (TW) 113119174

(51) Int. Cl. B32B 19/04; B32B 5/16; B32B 19/02; B32B 27/08; B32B 27/28; B32B 27/32; B32B 27/36

(52) U.S. Cl. CPC B32B 19/045; B32B 5/16; B32B 19/02; B32B 27/08; B32B 27/285; B32B 27/32; B32B 27/36; B32B 2250/03; B32B 2260/025; B32B 2260/046; B32B 2262/062; B32B 2307/4023; B32B 2307/4026; B32B 2307/41; B32B 2307/412; B32B 2307/75; B32B 2471/00

(57) ABSTRACT

A formula for an eco-friendly plastic flooring product including a main plastic containing 20 wt % to 35 wt % of polyethylene terephthalate (PET) or polypropylene (PP); 5 wt % to 15 wt % of polyolefin elastomers (POE); 2 wt % to 6 wt % of maleic anhydride grafted polymers; 5 wt % to 15 wt % of a plant fiber; 30 wt % to 50 wt % of an inorganic filler comprising calcium carbonate, talc, or kaolin; 0.5 wt % to 5 wt % of a hydrolysis inhibitor; and 0.5 wt % to 1.5 wt % of lubricants.

### FIELD OF INVENTION

A formula for an eco-friendly plastic material, in particular a formula for an eco-friendly plastic flooring product.

### BACKGROUND OF THE INVENTION

Plastic flooring has gained widespread popularity in modern society due to its durability, ease of cleaning, and relatively low cost. However, the majority of plastic flooring products on the market today are made primarily from polyvinyl chloride (PVC). Throughout its lifecycle, from materials taking to making, using, and disposing, PVC can pose significant risks to the environment and human health. Plasticizers and stabilizers are often added to modify the properties of PVC, including phthalate plasticizers, which are known to disrupt the endocrine system, affect reproduction and children's health, and even cause cancer. These PVC additives may also leach into water, air, and food over time, adversely impacting human health and natural ecosystems. In particular, when these floors are incinerated, large amounts of toxic gases will be released, exacerbating air pollution problems.

To reduce the environmental and health impacts of PVC flooring, some in the industry have sought to improve manufacturing processes, such as adopting more energy-efficient production technologies to reduce energy consumption and emissions. Others have attempted to change the formulation to lower the PVC content, thereby reducing the environmental burden. However, as there is currently no completely alternative material that can meet all performance requirements, the plastic flooring industry continues to use PVC and related plasticizers as the main component, thus not truly achieving the goal of eco-friendly plastic flooring.

In view of this, the development of an eco-friendly plastic flooring product that completely eliminates the use of PVC while maintaining or even enhancing performance has become an urgent issue to be solved in the relevant field.

### SUMMARY OF THE INVENTION

To develop an eco-friendly plastic flooring product that completely eliminates the use of PVC while maintaining or even enhancing performance, the present invention provides a formula for an eco-friendly plastic flooring product comprising the following components: a main plastic containing 20 wt % to 35 wt % of polyethylene terephthalate (PET) or polypropylene (PP); 5 wt % to 15 wt % of a polyolefin elastomer (POE); 2 wt % to 6 wt % of a maleic anhydride grafted polymer; 5 wt % to 15 wt % of a plant fiber; 30 wt % to 50 wt % of an inorganic filler comprising calcium carbonate, talc, or kaolin; 0.5 wt % to 5 wt % of a hydrolysis inhibitor; and 0.5 wt % to 1.5 wt % of lubricants.

Wherein the polyolefin elastomer is a polyolefin copolymer containing an α-olefin.

Wherein the maleic anhydride grafted polymer is maleic anhydride grafted polyethylene, maleic anhydride grafted polypropylene, or maleic anhydride grafted ethylene-propylene copolymer, and the grafting rate of the maleic anhydride grafted polymer is between 0.5% and 1.0%.

Wherein the equivalent particle diameter of the plant fiber is between 0.05 mm and 0.60 mm.

Further, the plant fiber is rice husk.

Wherein the hydrolysis inhibitor comprises carbodiimide.

The present invention also provides an eco-friendly plastic flooring product comprising sequentially: a stone-plastic core layer formed by mixing, compounding, and extrusion molding using the eco-friendly plastic flooring formula according to any one of claims 1 to 6; a print film disposed on the stone-plastic core layer; and a transparent wear layer disposed on the print film.

Wherein the print film is an opaque white thermoplastic plastic film comprising PET, polyethylene terephthalate glycol (PETG), or PP; and the print film has an ink pattern printed thereon.

Wherein the transparent wear layer is PET, PETG, or PP.

From the above description, it can be seen that the present invention has the following features:
1. The eco-friendly plastic flooring formula and eco-friendly plastic flooring product of the present invention are completely free of PVC or chlorinated polyethylene (CPE) and do not require the addition of corresponding plasticizers, greatly reducing the harm to the environment and health. During the manufacturing, use, and disposal processes, no harmful gases or chemicals to humans and the environment are released, thus helping to reduce air and water pollution, protect the ecological environment and ensure the health of users, it's a plastic flooring formula and product that truly achieves eco-friendly.
2. The eco-friendly plastic flooring formula and eco-friendly plastic flooring product of the present invention use PET or PP as the main plastic, which completely replaces PVC. However, the eco-friendly plastic flooring formula of the present invention can achieve excellent flooring material properties and possess better wear resistance.
3. The eco-friendly plastic flooring formula and the eco-friendly plastic flooring product of the present invention use plant fibers as organic fillers, which can further reduce the plastic content of the eco-friendly plastic flooring product, thereby reducing its environmental impact and resource consumption, which can also recycle agricultural waste that traditionally causes severe air pollution by incineration, and effectively increase the strength and durability of the flooring product.

### BRIEF DESCRIPTION OF THE DRAWINGS

FIG. 1 is a perspective schematic view illustrating a preferred embodiment of the present invention; and

FIG. 2 is a perspective schematic view illustrating a preferred embodiment of the present invention.

### DETAILED DESCRIPTION OF THE PREFERRED EMBODIMENTS

In order to more clearly describe the technical solutions of the embodiments of the present invention, a brief introduction to the drawings used in the description of the embodiments is provided below. Obviously, the drawings in the following description are only some examples or embodiments of the present invention. Those skilled in the art will be able to apply the present invention to other similar scenarios without creative effort based on these drawings. Unless it is apparent from the language context or otherwise indicates, the same reference numbers in the drawings represent the same structures or operations.

As shown in the present invention and claims, unless the context clearly suggests otherwise, the words “a”, “an”, “one”, or “the” do not particularly refer to the singular and may also include the plural. In general, the terms “comprising” and “including” merely indicate the inclusion of the explicitly identified steps and elements, and these steps and elements do not constitute an exclusive listing, and the methods or devices may also include other steps or elements.

Flow charts are used in the present invention to illustrate the operations performed by the systems according to embodiments of the present invention. It should be understood that the preceding or subsequent operations are not necessarily executed in order. Instead, the various steps can be processed in reverse order or simultaneously. At the same time, other operations can also be added to these processes, or one or more steps can be removed from these processes.

The present invention discloses a formula for an eco-friendly plastic flooring product, which comprises the following components: a main plastic containing 20 wt % to 35 wt % of PET or PP; 5 wt % to 15 wt % of a polyolefin elastomer; 2 wt % to 6 wt % of a maleic anhydride grafted polymer; 5 wt % to 15 wt % of a plant fiber; 30 wt % to 50 wt % of an inorganic filler; 0.5 wt % to 5 wt % of a hydrolysis inhibitor; and 0.5 wt % to 1.5 wt % of lubricants.

Wherein the main plastic can be PET or PP, or a mixture of PET and PP.

Preferably, the PET or PP can be made from recycled materials.

Wherein the polyolefin elastomer is a polyolefin copolymer containing an α-olefin. Preferably, the polyolefin elastomer is poly(ethylene-co-1-octene). The polyolefin elastomer is used to improve the impact resistance of the eco-friendly plastic flooring material made from the formula.

Wherein the maleic anhydride grafted polymer is maleic anhydride grafted polyethylene, maleic anhydride grafted polypropylene, or maleic anhydride grafted ethylene-propylene copolymer. Preferably, the grafting rate of the maleic anhydride grafted polymer is between 0.5% and 1.0%.

Wherein the plant fiber is a fiber whose main components are cellulose, hemicellulose, or lignin. Preferably, the plant fiber is in powder form, and the equivalent particle diameter of the plant fiber is between 0.05 mm and 0.60 mm.

More preferably, the plant fiber is rice husk. Rice is dried prior to milling and edible rice grains are obtained after milling, leaving a large amount of rice husk which can be ground into a powder and added to the formulation as a filler. Rice husk is derived from photosynthesis, with the main carbon source being carbon dioxide from the air. To avoid burning the discarded rice husk and converting it back into carbon dioxide, using rice husk as a filler for plastic products is also a carbon sequestration method.

Preferably, the inorganic filler is calcium carbonate, talc, or kaolin.

Preferably, the hydrolysis inhibitor comprises carbodiimide. More preferably, the hydrolysis inhibitor is N,N′-bis(2,6-diisopropylphenyl) carbodiimide (CAS Reg. No. 2162-74-5). The hydrolysis inhibitor can slow down the hydrolysis of the PET during heat processing and increase the average molecular weight of the main plastic.

Preferably, the lubricants contain polar and non-polar materials. More preferably, the lubricants contain fatty acid esters, polyol esters, and polyethylene waxes.

Preferably, according to the weight percentages of the components in the eco-friendly plastic flooring formula, the materials are weighed and fed into a high-speed mixer at a temperature below 130° C. and mixed at 1000 rpm for 3 to 5 minutes to form a uniform powder mixture. Since moisture under heat processing conditions will promote PET hydrolysis, a vacuum is applied during this mixing process to remove as much water vapor as possible. The powder mixture is then discharged and stirred at low speed to cool the powder mixture to below 45° C. The powder mixture is then fed into a twin-screw extruder and compounded and extruded at a compounding temperature range of 190° C. to 230° C. to form a flat plate-shaped stone-plastic core layer 10. The stone-plastic core layer 10 is then hot-pressed or continuously laminated with at least one print film 20 and one transparent wear layer 30 to form the eco-friendly plastic flooring product.

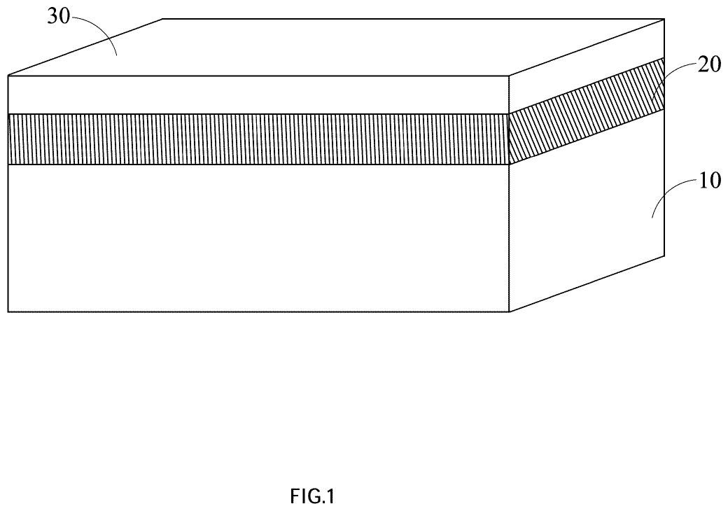

The present invention also includes an eco-friendly plastic flooring product made from the eco-friendly plastic flooring formula. Reference is made to FIG. 1, which shows a preferred embodiment of the eco-friendly plastic flooring product. The eco-friendly plastic flooring product comprises the stone-plastic core layer 10, the print film 20 disposed on the stone-plastic core layer 10, and the transparent wear layer 30 disposed on the print film 20. The layers are tightly bonded into a flat plate shape by static hot pressing or dynamic continuous hot lamination.

Wherein the print film 20 is an opaque white thermoplastic plastic film, and an ink pattern is printed on the print film 20. The white film corresponds to the same type of plastic used for the underlying stone-plastic core layer and may include PET, PETG, or PP. The PETG mentioned in this invention is polyethylene terephthalate glycol or glycol-modified polyethylene terephthalate.

Wherein the transparent wear layer 30 is disposed on the print film 20, and the transparent wear layer may include PET, PETG, or PP. Preferably, the transparent wear layer 30 is PETG due to its excellent transparency and wear resistance.

Preferably, the thickness of the transparent wear layer 30 is 150 to 300 μm. Since the transparent wear layer 30 is made of PET, PETG, or PP, which are more wear-resistant than traditional PVC, it can be thinner and more eco-friendly than the wear-resistant layer of traditional PVC plastic flooring, and it will not release toxic substances into the environment during long-term wear, thus ensuring indoor air quality and user health. Under the same conditions (H-18 abrasive wheel, 250 g load, ground to 1000, 3000, and 5000 revolutions, respectively), a wear evaluation was performed on different materials. In a preferred embodiment using PP as the transparent wear layer 30 of the eco-friendly plastic flooring product, the wear was only about two-thirds compared to the traditional PVC wear layer. In another preferred embodiment using PETG as the transparent wear layer 30 of the eco-friendly plastic flooring product, the wear was only about one-sixth compared to the traditional PVC wear layer.

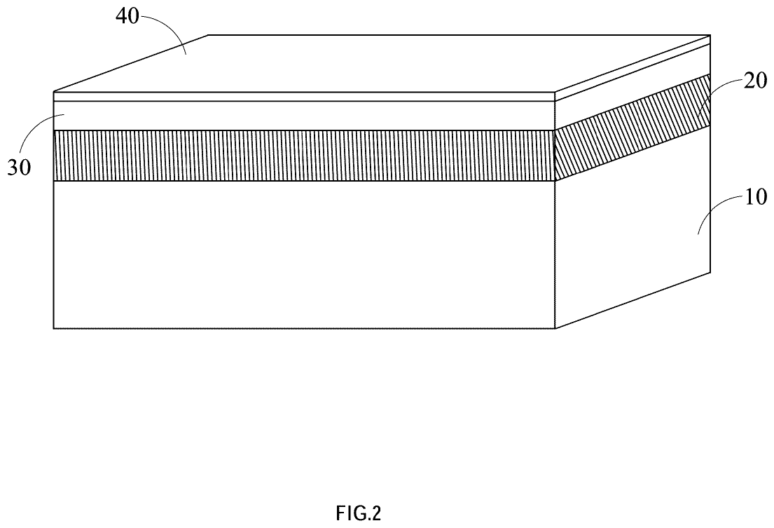

Reference is made to FIG. 2, which shows another preferred embodiment of the eco-friendly plastic flooring product of the present invention. In this embodiment, the eco-friendly plastic flooring product comprises, from bottom to top, the stone-plastic core layer 10, the print film 20, the transparent wear layer 30, and a surface scratch-resistant coating layer 40. The stone-plastic core layer 10, the print film 20, and the transparent wear layer 30 are the same as described in the previous embodiment. The surface scratch-resistant coating layer 40 is applied on the wear layer 30 and is a polyacrylate layer formed by UV-curing of an acrylate monomer and having a thickness of 5 to 20 μm. The scratch-resistant coating layer 40 provides short-term enhanced scratch and wear resistance, controls surface gloss, or imparts other specified functions through various additives.

From the foregoing description, it can be seen that the present invention achieves the following effects:
1. The eco-friendly plastic flooring formula and eco-friendly plastic flooring product of the present invention are completely free of PVC or chlorinated polyethylene (CPE) and do not require the addition of corresponding plasticizers, greatly reducing the harm to the environment and health. During the manufacturing, use, and disposal processes, no gases or chemicals harmful to humans and the environment are released, thus helping to reduce air and water pollution, protect the ecological environment and ensure the health of users, it's a plastic flooring formula and product that truly achieves eco-friendly.
2. The eco-friendly plastic flooring formula and eco-friendly plastic flooring product of the present invention use PET or PP as the main plastic, which completely replaces PVC. However, the eco-friendly plastic flooring formula of the present invention can achieve excellent flooring material properties and possess better wear resistance.
3. The eco-friendly plastic flooring formula and the eco-friendly plastic flooring product of the present invention use plant fibers as organic fillers, which can further reduce the plastic content of the eco-friendly plastic flooring product, thereby reducing its environmental impact and resource consumption, which can also recycle agricultural waste that traditionally causes severe air pollution by incineration, and effectively increase the strength and durability of the flooring product.

It should be noted that based on the explanations and elaborations in the above specification, those skilled in the art to which this disclosure relates may also make changes and modifications to the above implementation modes. Therefore, this disclosure is not limited to the specific implementation modes disclosed and described above, and some equivalent modifications and changes to this disclosure should also be within the scope of protection of the claims of this disclosure. In addition, although certain terms are used in this disclosure, these terms are used for convenience of description only and do not impose any limitations on the invention.

What is claimed is:

1. A formula for an eco-friendly plastic flooring product, wherein a stone-plastic core layer comprises the following components:
a main plastic containing 20 wt % to 35 wt % of PET or PP;
5 wt % to 15 wt % of a polyolefin elastomer;
2 wt % to 6 wt % of maleic anhydride grafted polymers;
5 wt % to 15 wt % of a plant fiber;
35 wt % to 50 wt % of an inorganic filler, wherein the inorganic filler is calcium carbonate, talc, or kaolin;
0.5 wt % to 5 wt % of a hydrolysis inhibitor; and
0.5 wt % to 1.5 wt % of lubricants.

2. The formula for an eco-friendly plastic flooring product according to claim 1, wherein the polyolefin elastomer is a polyolefin copolymer containing an α-olefin.

3. The formula for an eco-friendly plastic flooring product according to claim 1, wherein the maleic anhydride grafted polymer is maleic anhydride grafted polyethylene, maleic anhydride grafted polypropylene, or maleic anhydride grafted ethylene-propylene copolymer, and the grafting rate of the maleic anhydride grafted polymer is between 0.2% and 1.0%.

4. The formula for an eco-friendly plastic flooring product according to claim 2, wherein the maleic anhydride grafted polymer is maleic anhydride grafted polyethylene, maleic anhydride grafted polypropylene, or maleic anhydride grafted ethylene-propylene copolymer, and the grafting rate of the maleic anhydride grafted polymer is between 0.2% and 1.0%.

5. The formula for an eco-friendly plastic flooring product according to claim 1, wherein the equivalent particle diameter of the plant fiber is between 0.05 mm and 0.60 mm.

6. The formula for an eco-friendly plastic flooring product according to claim 4, wherein the equivalent particle diameter of the plant fiber is between 0.05 mm and 0.60 mm.

7. The formula for an eco-friendly plastic flooring product according to claim 6, wherein the plant fiber is rice husk.

8. The formula for an eco-friendly plastic flooring product according to claim 1, wherein the hydrolysis inhibitor comprises carbodiimide.

9. The formula for an eco-friendly plastic flooring product according to claim 7, wherein the hydrolysis inhibitor comprises carbodiimide.

10. An eco-friendly plastic flooring product, comprising sequentially:
a stone-plastic core layer, formed by mixing, compounding, and extrusion molding using the eco-friendly plastic flooring formula according to claim 1;
a print film, disposed on the stone-plastic core layer; and
a transparent wear layer, disposed on the print film.

11. The eco-friendly plastic flooring product according to claim 10, wherein:
the print film is an opaque white thermoplastic plastic film comprising PET, PETG, or PP; and the print film has an ink pattern printed thereon.

12. The eco-friendly plastic flooring product according to claim 11, wherein the transparent wear layer comprises PET, PETG, or PP.

13. An eco-friendly plastic flooring product, comprising sequentially:
a stone-plastic core layer, formed by mixing, compounding, and extrusion molding using the eco-friendly plastic flooring formula according to claim 4;
a print film, disposed on the stone-plastic core layer; and
a transparent wear layer, disposed on the print film.

14. The eco-friendly plastic flooring product according to claim 13, wherein:
the print film is an opaque white thermoplastic plastic film comprising PET, PETG, or PP; and the print film has an ink pattern printed thereon.

15. The eco-friendly plastic flooring product according to claim 14, wherein the transparent wear layer comprises PET, PETG, or PP.

16. An eco-friendly plastic flooring product, comprising sequentially:
a stone-plastic core layer, formed by mixing, compounding, and extrusion molding using the eco-friendly plastic flooring formula according to claim 9;
a print film, disposed on the stone-plastic core layer; and
a transparent wear layer, disposed on the print film.

17. The eco-friendly plastic flooring product according to claim 16, wherein:
the print film is an opaque white thermoplastic plastic film comprising PET, PETG, or PP; and the print film has an ink pattern printed thereon.

18. The eco-friendly plastic flooring product according to claim 17, wherein the transparent wear layer comprises PET, PETG, or PP.
